(19) United States
(12) Patent Application Publication
(10) Pub. No.: US 2025/0312626 A1
(43) Pub. Date: Oct. 9, 2025

(54) Electronically Controlled Tactile Alerting Systems for Breathing Apparatus

(71) Applicant: MSA Technology, LLC, Cranberry Township, PA (US)

(72) Inventors: Marco Tekelenburg, Zelienople, PA (US); Jason Paul Eaton, Hunker, PA (US); David Dressner, Cranberry Township, PA (US); Christopher Henley, Cranberry Township, PA (US); Tyler Karloski, Cranberry Township, PA (US)

(21) Appl. No.: 19/171,882

(22) Filed: Apr. 7, 2025

Related U.S. Application Data
(60) Provisional application No. 63/575,196, filed on Apr. 5, 2024.

(51) Int. Cl. A62B 9/00; A62B 27/00

(52) U.S. Cl. CPC A62B 9/006; A62B 27/00

(57) ABSTRACT

An electronically controlled tactile alert system for use in equipment, such as personal protective equipment like respiratory protection systems used in firefighting, comprising one or more sensors, a processor, and an actuator to generate impulses that are tactilely sensed by a user of the equipment.

### CROSS-REFERENCE TO RELATED APPLICATIONS

This application claims the benefit of U.S. Provisional Patent Application No. 63/575,196 filed Apr. 5, 2024, the disclosure of which is incorporated by reference herein in its entirety.

### FIELD

This disclosure relates to the integration of electronically controlled tactile alerting systems within a breathing apparatus, such as a self-contained breathing apparatus (SCBA).

### BACKGROUND

Alert systems for firefighting Personal Protective Equipment (PPE) are designed to enhance the safety and situational awareness of firefighters by providing real-time information about various aspects of their health, environment, and equipment status. These systems are crucial in improving response times, reducing risks, and ensuring firefighters' safety during emergency situations. Alert systems for firefighting PPE include Personal Alert Safety Systems (PASS), temperature and gas sensors, heart rate and health monitoring systems, location tracking and geofencing, communication systems, environmental monitoring systems, and firefighter down systems.

Alert systems often rely on audible or visual cues, which, depending on the environment, may be suboptimal. Such alert systems may not effectively provide their alert function in all operating environments, may provide alerts that are difficult to control, or may provide alerts that are distracting in a manner that outweighs the benefits of the alerts.

There is a need for an alert system that has improved detectability and increases functionality of alerts without interfering in other vital operations. Certain systems and methods herein may provide alerting systems for breathing apparatus that overcome performance limitations associated with pneumatically controlled audible alerting systems, electronically controlled audible alerting systems, and electronically controlled visual alerting systems.

### SUMMARY

Provided herein is a tactile alerting system for indicating information to a user of a respiratory protection system, comprising:
a. a first sensor configured to sense a condition, event, or operational stage and to generate a first sensor signal;
b. a processor configured to (i) receive the first sensor signal; (ii) identify a first alert condition based on the first sensor signal; and (iii) transmit a first alert signal when the first alert condition is identified; and
c. an actuator configured to receive a command based on the first alert signal and generate one or more tactile impulses in one or more components of the respiratory protection system based on the command.

The processor may be further configured to (i) receive a second signal from the first sensor, (ii) identify a subsequent alert condition based on the second signal from the first sensor, and (iii) transmit a subsequent alert signal.

In certain embodiments, the tactile alerting system may further comprise a second sensor configured to generate a second sensor signal, wherein the processor is configured to identify a second alert condition based on the second sensor signal and transmit a second alert signal when the alert signal is identified, and wherein the tactile alerting system is configured to command the actuator 112 to generate tactile impulses based on the second alert signal.

In certain embodiments, the command received by the actuator is from an actuator control board that has received an alert signal from the processor.

The first and second sensors may be any type of sensor, such as a pressure sensor configured to monitor an air supply associated with a breathing apparatus or a motion detector.

Tactile alerts may comprise a pattern of a plurality of impulses of varying duration, intensity, amplitude, and/or frequency. The system may be configured to vary the amplitude, frequency, or timing of tactile impulse(s) generated by the actuator based on the sensor from which the sensor signal is received, time in alert condition, or in response to sensor signal levels. In certain embodiments, the processor is configured to receive information from a remote location and generate tactile alerts in response.

In certain implementations of the tactile alert system, the actuator is directly or indirectly coupled to a respiratory mask, such as on a regulator of an SCBA or air-purifying mask.

In certain implementations of the tactile alert system, the actuator may be electronically activated and/or deactivated. In certain embodiments, the mechanical impulse(s) of the actuator are generated by rotating a rotationally imbalanced mass.

In another aspect, provided herein is a system utilizing an electronically controlled tactile actuator to enable improved respiratory protection system demand valve performance by aiding in expulsion of contaminants, debris, or liquid in a respiratory protection system demand valve or overcoming static friction. In certain embodiments, the electronically controlled tactile actuator to increase agitation of a cleaning solution applied to a respiratory protection system demand valve.

In another aspect, provided herein is a system to determine one or more operational states of a respiratory protection system comprising: (a) an actuator configured to generate an impulse-induced acoustic signal based on the one or more operational states of the respiratory protection system; (b) a first acoustic sensor configured to receive the impulse-induced acoustic signal and transmit a first acoustic sensor signal; and (c) a processor configured to: (i) receive the first acoustic sensor signal from the first acoustic sensor; (ii) identify an operational state based on the first acoustic sensor signal; and (iii) transmit information regarding the operational state of the respiratory protection system to a device wherein the user of the respiratory protection system can receive information related to the operational state. In certain embodiments, the acoustic sensor is a microphone. In certain implementations the processor may be configured to request the generation of an impulse-induced acoustic signal based on the one or more operational states of the respiratory protection system. For example, the operational state of the respiratory protection system may be indicative of a state of connectivity of the respiratory protection system to the user. In another example, the operational state of the respiratory protection system may be indicative of a state of proper connectivity of a regulator to a facepiece.

In another aspect, provided herein is a tactile alerting system for indicating information to a user of a respiratory protection system, comprising: (a) a processor configured to: (i) receive remote information; (ii) identify a first alert condition based on the remote information; and (ii) transmit a first alert signal when the first alert condition is identified; and (b) an actuator configured to receive a command based on the first alert signal and generate one or more tactile impulses in one or more components of the respiratory protection system based on the command. In certain embodiments, the remote information is a signal from a tactile alerting system of another user, for example, a signal from a motion sensor. In other embodiments, the remote information is from a remote monitoring location, such as an evacuation order.

### BRIEF DESCRIPTION OF THE DRAWINGS

FIG. 1 depicts an example implementation of a tactile alert system.

FIG. 2 is a diagram depicting the implementation of a tactile alert system as part of an electronic control system of a respiratory protection system.

FIG. 3 depicts one embodiment of the implementation of an actuator on an SCBA regulator.

FIG. 4 depicts a broken-out section view of the embodiment of FIG. 3 to reveal components inside the regulator housing.

FIG. 5 depicts relative placement of an actuator and processor on a full-face respirator mask.

FIG. 6 depicts relative placement of an actuator and processor on a cross-sectional view of a regulator.

FIG. 7 is a block diagram depicting a system diagram for an exemplary tactile facepiece.

FIG. 8 is a flow diagram depicting a method for operating a tactile alerting system for monitoring an event, condition, or operational state of personal protective equipment (PPE).

FIG. 9 depicts an example implementation of a tactile alert system.

FIG. 10 depicts a processing system that includes a computer-implemented tactile alert system.

### DETAILED DESCRIPTION

The following information is provided to assist the reader in understanding the devices, systems and/or methods disclosed below and the environment in which such devices, systems and/or methods will typically be used. The terms used herein are not intended to be limited to any particular narrow interpretation unless clearly stated otherwise in this document. References set forth herein may facilitate understanding of the devices, systems and/or methods or the background. The disclosure of all references cited herein are incorporated by reference. Certain examples herein are described in the context of a breathing apparatus implementation. But those examples may equally apply to other environments, such as in conjunction with other types of PPE such as protective clothing (e.g., fireman's jacket, pants, helmet) or accessories (e.g., a harness, a fire hose, a ladder).

As noted above, alert systems often rely on audible or visual cues, which, depending on the environment, may limit or hinder PPE performance. For example, audible cues are typically implemented loudly to ensure detectability by a user. But in a high-stress, chaotic environment like a fire, there are often many sources of loud noise, such as the roar of the fire, equipment, radios, and sirens. Audible alarms add to that noise, potentially resulting in overload. Such overload may make it difficult for the user to distinguish important signals and degrade the user's ability to hear (and transmit) voice communications, other audible alarms, and ambient noise. It may also be difficult for a user to distinguish between their own alarm and team members' alarm when multiple users are in proximity of each other. Heavy reliance on audible alerts could lead to “alarm fatigue,” where users may become desensitized to certain alarms, potentially ignoring them, or failing to respond quickly. Frequent false alarms may cause unnecessary panic or reduce the effectiveness of the alarm system, as users might ignore or become complacent with the alerts. On the other hand, constantly hearing alarms, particularly in high-pressure situations, can increase stress levels for users, especially if the alarm is triggered unnecessarily.

In some applications, audible cues are often pneumatically triggered. For example, cylinder pressure may be used as an indicator of an amount of breathable air that is available in a respiratory device (e.g., a respiratory device used in a fire fighting environment or an underwater environment). Cylinder pressure is often detected pneumatically by including one or more pneumatic valves in fluid connection with the cylinder. Upon reaching the predetermined pressure value (e.g., 25-35% of the rated service pressure), the pneumatic valve changes state to actuate an audible alarm mechanism, such as a whistle or bell, in fluid connection with the pneumatic valve(s). While pneumatically triggered alarms can provide an important signal to a user, such alarms have limited functionality in terms of operating modes and user interaction. For example, functionality may be limited to only detecting pneumatic state changes, such as low cylinder pressure conditions, and cannot be utilized for non-pneumatic alarms and notifications. Functionality may also be limited in the amount of control a user has over the alert. For example, following actuation, audible alarms typically sound continuously and cannot be turned off or otherwise controlled.

Visual cues may be disadvantaged for many of the same reasons. For example, firefighting often occurs in dark, smoky, or low-visibility conditions, where seeing visual signals can be extremely challenging. In some instances, smoke, debris, or poor lighting can obstruct or distort the view of the visual alarm, making it difficult for firefighters to notice the alert. In other instances, high light levels may make visual indications (e.g., LED indicator lights) difficult to detect. Other alarms (e.g., visual alarms) can also contribute to sensory overload, especially if there are multiple visual indicators, flashing lights, or screens in a chaotic environment.

Visual cues are often electronically controlled which can increase operating modes and control. However, electronically controlled visual alerting systems include limitations relating to the placement, performance, and detectability of visual user interfaces. Visual user interfaces are ideally placed within the user's field of view to enhance visibility and minimize the need for a breathing apparatus user to move their head or use their hands to access a visual user interface. When placed within the user's field of view, visual user interfaces may impede the user's vison. In low ambient light conditions, visual user interfaces may impede visibility due to glare. In high ambient light conditions, visual user interfaces may be difficult to see due to glare. In addition to the noted limitations, visual user interfaces are susceptible to being missed or ignored due to the significant presence of other visual user interfaces, stimuli, and noise within a breathing apparatus user's operating equipment and environment.

There is a need for an alert system that has improved detectability and increases functionality of alerts without interfering in other vital operations. Certain systems and methods herein may provide tactile alerting systems (e.g., for a breathing apparatus) that overcome performance limitations associated with pneumatically controlled audible alerting systems, electronically controlled audible alerting systems, and electronically controlled visual alerting systems.

Tactile alarms provide feedback through physical sensations and offer a more direct, personal, and hands-on way of alerting the wearer to a specific issue. The tactile alert systems provided herein may be, at least in part, electronically controlled by use of a processor integrated into the equipment, such as into the regulator of a respirator, and uses mechanical impulse(s), such as vibrations, to communicate alert conditions, e.g., of the environment or the equipment to the user. Compared to other types of alert systems, such as audible or visual systems, tactile alerts can be easily detected in loud environments and those with low visibility. A user is instantly aware of the alert and can, in turn, react quickly to it. Tactile alerts reduce sensory overload that is commonly experienced with other alert types and offer a more discreet alert system that does not contribute to visual or auditory clutter. Further, electronically controlled tactile alerting systems can be used for non-pneumatic alarms and offer increased operating modes and control.

As will be described in further detail herein, an electronically controlled tactile alerting system may be used for alarms, notifications, acknowledgements, prompts, and other user interfaces. The electronically controlled tactile alerting systems may exist independently or may be combined with one or more additional pneumatically controlled audible alerting systems, pneumatically controlled tactile alerting systems, electronically controlled audible alerting systems, and/or electronically controlled visual alerting systems.

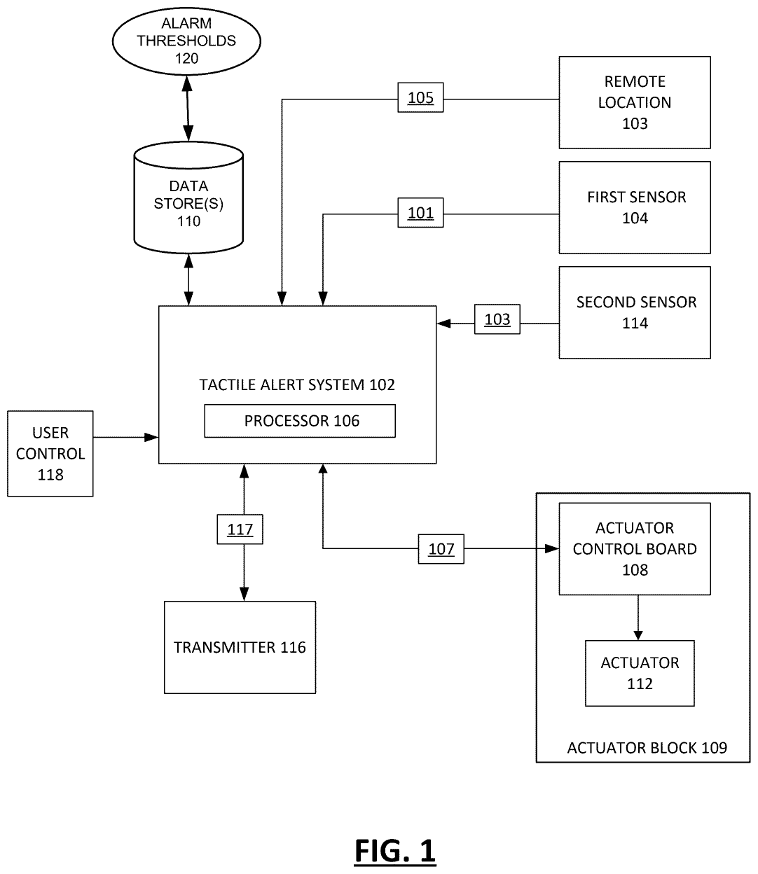

FIG. 1 depicts an example implementation of a tactile alert system 102. Such a system can be used for monitoring a condition, event, or operational state of equipment used by a user, to provide an alert to the user. The example system includes a first sensor 104 configured to sense a condition, event, or an operational state of the PPE such as air pressure of an air supply, and to generate a first sensor signal 101. The tactile alert system 102 includes a processor 106 that is configured to receive the first sensor signal 101 from the first sensor 104 and to identify a first alert condition based on the first sensor signal 101. For example, the processor 106 may receive a pressure signal associated with an air supply, e.g., cylinder or connection to a compressor, of a respiratory system. The pressure signal may be an electronic signal received from the first sensor 104, such as a pressure sensor in fluid communication with the air supply. The processor 106 is configured to interpret sensor signals received from the pressure sensor to identify an alert condition. The processor may identify the alert condition, e.g., by comparing the pressure signal to an alarm threshold 120 stored in a computer-readable data store (e.g., an FPGA, a read only memory, a memory storing configurable alarm thresholds). When an alert condition is identified (e.g., when the pressure signal from the first sensor 104 indicates that pressure has dropped below the air supply pressure alarm threshold), the processor 106 is configured to transmit an alert signal 107. The alert signal 107 is received by an actuator control board 108. The actuator control board 108 is configured to command an actuator 112 generate tactile impulse(s) upon receipt of the first alert signal 107 from the processor 106. Together, the actuator control board 108 and actuator 112 may be referred to as the actuator block 109.

A wide variety of other sensors may be utilized as the one or more sensors associated with the tactile alert system 102. Non-limiting examples of sensors that may be used to convey a sensor signal to the processor include pressure sensors, battery state sensors, motion sensors, temperature and gas sensors, heart rate and health monitoring sensors, breathing sensors, location sensors, and switch state sensors (e.g., Hall-effect sensors).

Numerous alert conditions may also be communicated to a user via a tactile alert system 102. Alert conditions may, for example, indicate remaining cylinder pressure alarms, end of service time alarms, low battery alarms, motionless state pre-alarms, motionless state full alarms, manually activated alarms, thermal alarms, evacuation alarms, physiological status alarms, location alarms, wireless connectivity alarms, breathing apparatus error state alarms, and team member alarms.

In certain embodiments, the processor 106 of a tactile alert system may be configured to receive sequential sensor signals from the same sensor, e.g., a pressure sensor, wherein the sequential sensor signals correspond to different alert conditions (e.g., different pressures). The processor 106 may be configured to send different alert signals corresponding to different impulse patterns for each sequential sensor signal to the actuator control board 108. For example, a tactile alert having a first pattern could be generated when an air supply falls to 50% and a subsequent tactile alert having a subsequent, different pattern, could be generated when the air supply falls lower, e.g., to 35% or 10%. Such subsequent patterns could increase in impulse intensity or frequency to convey the urgency of addressing the alert to the user.

The tactile alert system 102 may take a variety of forms. In some implementations, the system 102 may receive input from multiple sensors (two or more) and generate tactile (or other) alarms based on those received signals. For example, a second sensor 114 is configured to generates a second sensor signal 103. In one example, alarms may be generated based on signals received from individual sensors. For example, the second sensor 114 may be a heat sensor that detects when a user is in the presence of dangerous heat levels. The second sensor signal 103, here a heat level signal from the second sensor 114 may be compared to a heat level alarm threshold 108, where the processor 106 is configured to generate an alert signal 107 to the actuator block 109 when the associated threshold is surpassed. In another example, the second sensor 114 is a gas detector that detects the presence of one or more unsafe gases (e.g., poisonous gasses, flammable or explosive gasses) and transmits a corresponding second sensor signal 103. The processor 106 is configured to compare the second sensor signal 103 from the gas detector second sensor 114 to a threshold to generate an alert signal 107 to the actuator block 109. In some instances, the threshold associated with an alert may be low or zero, triggering an alert when any signal is received from a corresponding sensor. For example, the processor 106 may be configured to generate an alert signal 107 to effect a tactile alert when any level of an explosive gas is detected by the second sensor 114.

In some instances, the tactile alert system 102 may be configured to issue an alert based on signals from multiple sensors. For example, the first sensor 104 may provide a pressure signal indicating a level of air present in a respiratory system air supply. The second sensor 114 may be a biometric sensor that is monitoring respiration, heart rate, or other indicator of current stress and energy expenditure by the user. Data from the second sensor signal 103 may be used to calculate a rate of anticipated air usage of the user. When that anticipated air usage is deemed above a nominal rate, an alarm threshold 120 associated with air supply pressure may be adjusted (e.g., the default threshold of a pressure associated with 30% air remaining may be changed to a pressure associated with 40% air remaining when a high stress scenario is indicated by data from the second sensor 114). When that modified alarm threshold 120 is met by the pressure signal from the first sensor 104, an alert condition is identified, with a corresponding alert signal 107 being transmitted to the actuator control block 109.

As shown in FIG. 1, the processor 106 may also or alternatively be configured to receive information 105 from a remote location 115, identify an alert condition based on that information, and transmit an alert signal 107 to the actuator control block 109 to generate a tactile alarm. The information 105 may be a signal from another user, such as from a motion sensor, or may be information from a remote monitoring location, for example, an evacuation order. In certain embodiments, certain aspects of user control 118 may allow the user to acknowledge the information from the remote location 115 and/or transmit information back to the remote location 115.

For example, in certain examples, an alert condition may be identified from a signal 117 received via a radio or other network signal transmitter (e.g., Wi-Fi, Bluetooth, cellular, low power wide area (LPWA)) 116. For example, an evacuation signal may be broadcast by the transmitter 116 to one or several users indicating that the environment has been deemed unsafe, such that evacuation should occur. The evacuation signal may be transmitted and be relevant to all users. In one example, an evacuation signal may be transmitted along with a location or region-indicating signal, where the evacuation signal is relevant to some users but not all. For example, when operations are associated with a large structure, an evacuation order may be associated with a portion of the structure (e.g., the east wing), while operations should continue at other portions of the structure. A tactile alert system 102 may cross reference the location or region-indicating signal with location data from a sensor 104, 114 (e.g., an absolute position sensor like GPS, a relative position sensor indicating distance from a known point (e.g., RSSI from a known-location transmitter, gyroscopic or pedometer data from a last known point)) to determine whether the evacuation signal is relevant to the user of the tactile alert system 102, where an alert condition is detected when the location data indicates that the user is within the location or region associated with the evacuation order.

In another example where an important radio communication is incoming, a signal 117 may be transmitted by transmitter 116 to the users indicating that they should listen carefully to their radios in the immediate term. Upon receipt of such a signal 117 from the transmitter 116, the processor 106 is configured to identify an alert condition and to transmit an alert signal 107 to the actuator control block 109. In a further example, the transmitter 116 may transmit or relay a signal 117 from a nearby user (e.g., a Bluetooth signal requesting help from nearby users based on lack of motion by the nearby user) that triggers an alert condition.

In certain embodiments, the processor 106 is configured to signal to the actuator control block 109 to provide a common tactile alert regardless of the type of alert condition. For example, the common tactile alert may comprise a repeating one second on, one second off impulse at a 70% of maximum intensity indefinitely in response to any alert condition. In other examples, the processor 106 may be configured to vary the impulse output of the actuator 112 based on timing factors or type factors associated with an alert. In one example, the tactile alert system 102 may be configured to generate a high intensity impulse pattern during an initial period of an alert condition and a lower level impulse pattern during a later period (e.g., one second on, one second off, at 90% intensity for a first 15 seconds, followed by 0.5 seconds on, 2 seconds off at 50% intensity thereafter). In certain examples, the high intensity/low intensity impulse pattern may be periodically repeated, such as every two minutes. Such an operating pattern may balance ensuring that the user receives the alert while not overwhelming the user with constant high intensity alerts. While described in conjunction with the processor 106, it should be noted that in certain embodiments the actuator control board 108 may be configured to vary the impulse output of actuator 112 instead of, or in combination with, the processor 106.

In some implementations, the tactile alert system 102 may be configured to command different impulse patterns by the actuator 112 for different types of alerts. For example, the tactile impulse(s) may change in one or more of amplitude, frequency, and timing based the sensor from which the sensor signal is received. In another example, the tactile impulse(s) may change in one or more of amplitude, frequency, and timing based on time in alert condition. In yet another example, tactile impulse(s) may change in one or more of amplitude, frequency, and timing based on sensor signal levels. In this way, a tactile alert can comprise a pattern comprising a plurality of impulses of varying duration, intensity, amplitude, and/or frequency. For example, a low-pressure alert condition for a respiratory system air supply may result in a first impulse pattern (e.g., one second on, one second off, at 60% intensity), while an evacuation alert condition may result in a more urgent pattern (e.g., two seconds on, 0.5 seconds off, three seconds on, 0.5 seconds off, at 90% intensity). In one embodiment, the tactile alert system 102 may be configured to command the actuator block 109 during the occurrence of multiple alert conditions. For example, where both a low-pressure alert condition and a high temperature alert condition are both present, the tactile alert system 102 may be configured to command the actuator block 109 to generate an impulse pattern associated with the low pressure alert for 15 second followed by an impulse pattern associated with the high temperature alert for the next 15 seconds. The tactile alert system 102 may be configured to rotate through patterns associated with current alert conditions. In some examples, certain alert conditions (e.g., an evacuation alert condition) may take precedence, such that the actuator 112 executes only the pattern associated with that priority alert condition, with other patterns being suppressed during the priority alert condition.

In some embodiments, a tactile alert system 102 may include a user control 118. In one example, the user control 118 is an acknowledgement button. Based on receipt of an acknowledgement signal from the user control 118, the tactile alert system 102 may be configured to suppress or alter the alert signal 107 to the actuator block 109. That suppression may be permanent in some examples. In other examples, the suppression may be temporary, where the alert signal 107 is again transmitted to the actuator block 109 if the alert condition continues to be detected for more than a threshold amount of time (e.g., a time threshold stored at 120). In certain embodiments, some alert conditions (e.g., a priority evacuation alert) may not be available for suppression. In some embodiments, the tactile alert system 102 is configured to transmit a tuning signal to the actuator control block 109 to alter characteristics of the output impulses of the actuator 112 based on receipt of an acknowledgement signal (e.g., reducing intensity from 90% to 30%). The acknowledgement user control 118 provides the tactile alert system 102 the ability to be sure that an alert has been received by the user without distracting the user from other important activities.

The user control 118 may be implemented in other forms as well. In one example, the user control 118 may be a voice-activated interface associated with speech recognition functionality. In certain embodiments, the processor 106 may be configured to send a tuning signal to the actuator control block 109 upon receiving an acknowledgement signal initiated by the user, e.g., in response to tactile alert. The tuning signal may command the actuator block 109 to alter the active tactile impulse pattern, e.g., decrease the intensity, frequency, or duration, of the alert. In certain embodiments, the processor 106 may be configured to allow the user to manually tune the tactile alert, e.g., deactivate, reactivate, or decrease its intensity, frequency, or duration.

In certain embodiments, the user can manually activate and deactivate the actuator 112 (e.g., by electronically activating and/or deactivating) to produce impulses, such as vibrations, on demand, which may be useful in removing debris from the equipment, e.g., respirator or regulator of a respiratory protection system. For example, dirt, debris, or water may be expelled from a demand value of a regulator of an SCBA using impulses generated by the actuator 112. In another example, the mechanical impulses generated by the actuator 112 may be useful in agitating a cleaning solution used to clean the respiratory protection system, e.g., a demand value of a regulator.

In certain embodiments, the transmitter 116 is a two-way radio transmitter, where the user or the alert system 102 can send targeted or broadcast transmissions. In one example, one of the sensors 104, 114 is a motion sensor that detects motion of the user. When movement is not detected for more than a threshold period, an alert condition may be detected indicating that the user needs aid. In some embodiments, a motion-related alert may be implemented in phases. In such an implementation, a first-time threshold 120 may result in an alert signal 107 being transmitted to the actuator block 109 when motion is not detected for a first period (e.g., 30 seconds). This alerts the user that an alarm will be sent or broadcast via the transmitter 116 (e.g., an analog or digital signal to a remote command center, to other nearby users, to an onsite outpost, a loud audible alarm indicating the location of the user that is not moving) if the user does not move soon. A second time threshold 120 may trigger a second alert condition that commands the transmitter 116 to transmit or broadcast the user distress alarm. In embodiments, the transmitter 116 is configured to transmit all or a portion of status data tracked by the tactile alert system 102 to an outpost or remote monitoring location. The transmitter 116 may be configured to stream all or a portion of signal data received from sensors 104, 114 as well as all alert conditions detected, and acknowledgement signals received via the user control 118.

Use of a tactile alert system 102 may enable other types of alerts as well. For example, in some embodiments, the tactile alert system 102 may be configured to identify a status update alert condition. Such an alert condition may be based on expiration of a threshold period or based on a received status request signal received via the transmitter 116. The status update alert prompts the user requesting feedback. The prompt may, for example, take the form of Personal Accountability Report (PAR) requests, evacuation alarm receipt acknowledgement requests, team join requests, and incoming voice communications notifications. The user may respond to such a status update alert condition via a vocal response into a microphone, an acknowledgement entered via the user control 118, or otherwise. In embodiments, upon detection of a response to the status update alert condition, the status update alert condition may be cancelled by the tactile alert system 102.

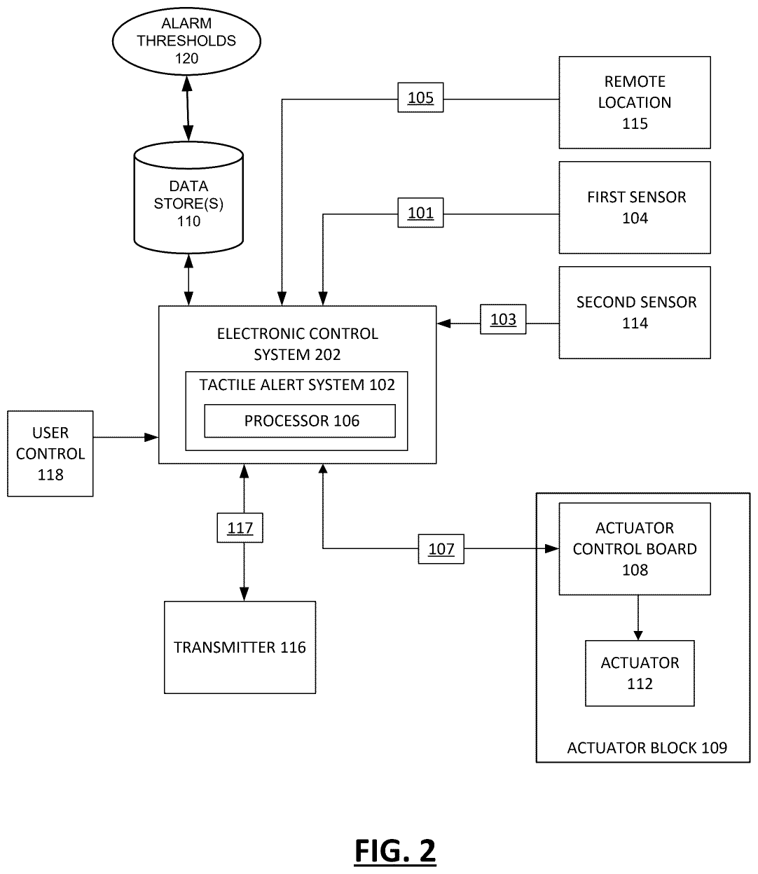

In embodiments, a tactile alert system 102 may be implemented as a component of a larger electronic control system 202 of the equipment, such as a respiratory protection system. FIG. 2 is a diagram depicting the implementation of a tactile alert system as part of an electronic control system 202 of a respiratory protection system. The electronic control system 202 is associated with operation of the second-stage regulator 204 mounted on the facepiece and may function to adjust the flow of air to meet the respiratory needs of the user. The electronic control system 202 may also control visual cues and other electronic functionalities, for example, a Heads-Up Display (HUD) 206, and other components of the PPE system, such as buddy lights, microphones, speakers, electronic audible alarms, voice signal processing systems, breathing sensors, pressure sensors, motion sensors, location sensors, radios, voice communication systems, thermal imaging cameras, gas detectors, location systems, physiological monitoring systems, and wireless connectivity systems. The HUD is an electronically controlled visual alerting solution that incorporates a display viewable to the user.

In the breathing apparatus comprising the tactile alert system 102 disclosed herein, the electronic control system 202 also relays and transmits signals for that tactile alert system 102. Accordingly, the electronic control system 202 also comprises a processor 106 configured to received sensor signals 101, 103 identify alert conditions based on those sensor signals, and transmit the alert signal 107 to an actuator block 109.

The actuator 112 may take a variety of forms. In some embodiment, the actuator may use electricity as an energy source to generate mechanical impulse(s). In other embodiments, the actuator may use air flow and/or pressure as an energy source to generate mechanical impulse(s). In certain embodiments, the impulse(s) created by the actuator are created by rotating an eccentric mass around an axis. In certain embodiment, that eccentric mass is an imbalanced mass.

In one example, the actuator 112 takes the form of a brushless DC motor that is configured to rotate based on a received input signal. The brushless motor includes a rotating shaft to which a mass is connected such that the center of gravity of the mass is offset from the shaft axis. This eccentric mass creates a rotational imbalance which generates impulses, such as vibrations, as the motor spins. Intensity of the perceived impulse(s) may be controlled by the speed of rotation of the brushless motor. Intensity of perceived impulse(s) may be increased by changing the mass or the eccentricity of the mass. In certain embodiments, the brushless motor may have a typical impulse or vibration amplitude in the range of 1G to 10 G (5 G preferred), a rated speed in the range of 1 rpm to 20,000 rpm, an eccentric mass in the range of 1 g to 5 g (2 g preferred), and an eccentricity of 1 mm to 5 mm (2 mm preferred). Advantageously, brushless motors tend to be more durable, particularly under the extreme conditions often faced by a user of PPE implementing the electronically controlled tactile alert system as disclosed herein. Higher strength bearings are typically used, higher grade permanent magnets are typically implemented, and cycle life failures induced by brush wear are avoided. While brushless motors have some distinct advantages, nothing in this disclosure should be construed to limit the application to a brushless motor. Specifically, brushed motors may have application for lower-cycle life tactile alerts, and may have cost advantages and motor drive circuitry advantages.

The actuator 112 may be implemented using non-motor-based mechanisms as well. In certain embodiments, the actuator 112 comprises a piezoelectric element, a linear actuator, an oscillating solenoid, or a pneumatic solenoid valve in operative connection with a pneumatic striker assembly. In certain embodiments, the tactile alerting system 102 comprises a motor, such as an eccentric rotating mass (ERM) motor, or a linear resonant actuator (LRA) motor.

The actuator control board 108, likewise, may be any by which the actuator may be controlled. One of skill in the art will be familiar with and be able to implement such a system for controlling an actuator, such as one described herein. For example, the actuator control board 108 may be a printed circuit board that is operatively connected to one or more control boards also implemented in the equipment. The actuator control board 108 sends commands to start and stop the actuator 112, e.g., start and stop rotation of the motor, by opening a power circuit to connect it to a voltage source for the start function. The actuator control board 108 also contains the electronics that disconnect the power source to stop the actuator 112, e.g., stop the motor, and opens a circuit that applies a reverse braking voltage or braking resistance. The actuator control board 108 may also comprise circuitry to manage power and safety features like overload protection and thermal shutdown. The actuator control board 108 may interpret alert signals 107 received from the processor 106 to regulate the amount of voltage available to the actuator 112, which allows the generation of varying impulse intensity and patterns by the actuator 112. Although described as a separate element, the actuator control board 108 may, in any embodiment, not be physically separated from other control boards or circuit boards. In any embodiment, control of the actuator 112 may be implemented in another control board, such as a central control board or regulator control board, used by the equipment, e.g., respiratory protection system.

The actuator 112 of the tactile alert system 102 may be implemented on a respiratory mask, e.g., of PPE, such as on a respirator or regulator. A respirator system may include a number of components, such as a facepiece, a regulator, a cylinder, a backplate to hold the cylinder, electronic connections between respirator sensor and control systems (e.g., a tactile alert system), pneumatically controlled audible alarms, electronically controlled visual alarms, one or more hoses, and the like.

In several representative embodiments, devices, systems, and methods hereof are described in connection with a facepiece or face mask for use in a pressure demand or demand supplied air respirator such as an SCBA. However, the devices, systems and methods hereof may be used in connection with any system in which breathing gas is supplied to a user. Additional applications include, but are not limited to, demand airline respirators, pressure demand airline respirators, constant flow airline respirators, constant flow SCBA, air purifying respirators, powered air purifying respirators, and breath responsive powered air purifying respirators. In certain embodiments, the respirator is an air-purifying respirator, such as a Powered Air Purifying Respirator (PAPR) or Air Purifying Respirator (APR). In certain embodiments, the tactile alerting system 102 is on a respirator of a full-face respirator of a SCBA, for example, installed on a regulator. In certain embodiments, the processor 106 of the tactile alerting system 102 is also on the mask, respirator, or regulator, e.g., of an SCBA.

In certain embodiments, a tactile alerting system 102 as disclosed herein is integrated into breathing apparatus comprising a combination respirator unit (CUR), which is operable between at least two modes, such as an SCBA mode and an APR or PAPR mode. One example of a CUR is disclosed in U.S. Patent Publication No. 2022/0080231 A1, the disclosure of which is incorporated herein by reference in its entirety. In a SCBA mode of operation, breathing air is delivered to a facepiece from a pressurized air tank via an airline connected to the facepiece and the pressurized air tank. In a PAPR or APR mode breathing air is delivered to the facepiece via an airline connected to a filter. When incorporated into a CUR, a tactile alarm system 102 could be used to indicate the operation mode of the CUR to the user. For example, the tactile alarm may actuate when a user switches from APR or PAPR mode to a Supplied Airline Respirator (SAR) or SCBA mode to notify the user that the CUR is operating in a mode that provides shorter duration of protection when compared to APR or PAPR modes. A tactile alarm could also be used to signal to the user the need or opportunity to switch from one mode to another. For example, a user may operate in an APR or PAPR mode when the operating environment has sufficient levels of oxygen. If the operating environment changes, or the user moves to another operating environment, oxygen levels may decrease, which would necessitate that the user switches to SAR or SCBA mode. A gas detection device 104, 114 that is connected to the CUR, either on the person or in proximity of the user, could detect oxygen levels and transmit this information to the CUR. The tactile alarm on the CUR could actuate when the oxygen level is deficient to signal to the user the need to switch modes. In alignment with this concept, the tactile alarm could also actuate when oxygen levels are sufficient, thereby notifying the user that it is safe to switch to an APR or PAPR mode (to extend usable duration).

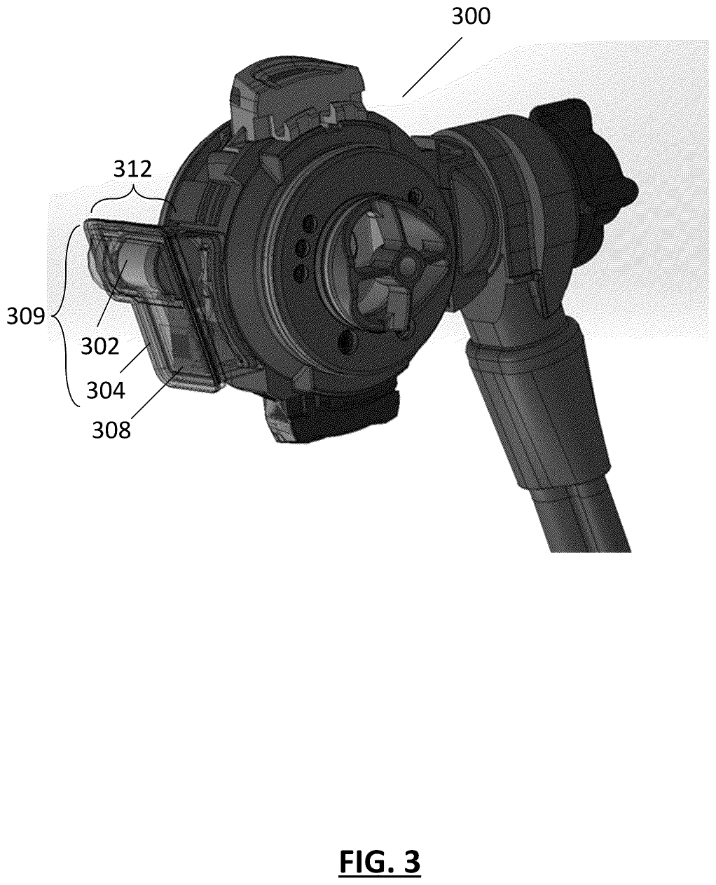

FIG. 3 depicts one embodiment wherein the actuator 312 is implemented onto the periphery of a regulator 300. In FIG. 3, the actuator 312 comprises a motor 302 and is encased within an actuator housing 304 (shown in FIG. 3 as transparent so motor 302 can be seen). The actuator 312 comprises motor 302 having an eccentric mass (not clearly visible in FIG. 3) that spins on an axis to create impulses, such as vibrations. An actuator control board 308 connected to the actuator 312 receives and transmits data between one or more central circuit boards (not shown) and the actuator 312.

The actuator housing 304 is sealed both with respect to the outside environment as well as the space inside the respirator/facepiece from which a user breathes to avoid contamination of the motor 302 by, e.g., a smoky environment, and to avoid contamination of the breathable air by the motor 302. The actuator housing 304, like the housing of other facepiece and regulator components, may be made of any durable material that can withstand high temperature conditions. In certain embodiments, the actuator housing 304 is made from a polymeric material such as, for example, polycarbonate, polyphenylsulfone, nylon, polyester or a composite polymer blend. In certain embodiments, the actuator housing 304 may be made from a polymer-based composite including glass fiber fill, carbon fiber fill, flame retardant additives, or other polymer modifiers.

In certain embodiments, the actuator block 309 (here comprising the actuator housing 304, motor 302, and actuator control board 308) can be provided as a reversibly removable component of a regulator 300 to permit modular adaptability of the regulator 300 with respect to the tactile alert system 102. In absence of the actuator 312, a plug could be installed in its place. This may be particularly advantageous, e.g., if the actuator 312 needs to be serviced. The actuator 312 can simply be detached and repaired separately without rendering the entire breathing apparatus inoperative.

Although FIG. 3 depicts the actuator 312 implemented onto the periphery of the regulator 300, the actuator 312 could be implemented in many other locations and/or configurations. For example, the actuator 312 could be configured to be contacted by air coming into the respirator/facepiece through the regulator 300, which can serve to cool the actuator 312.

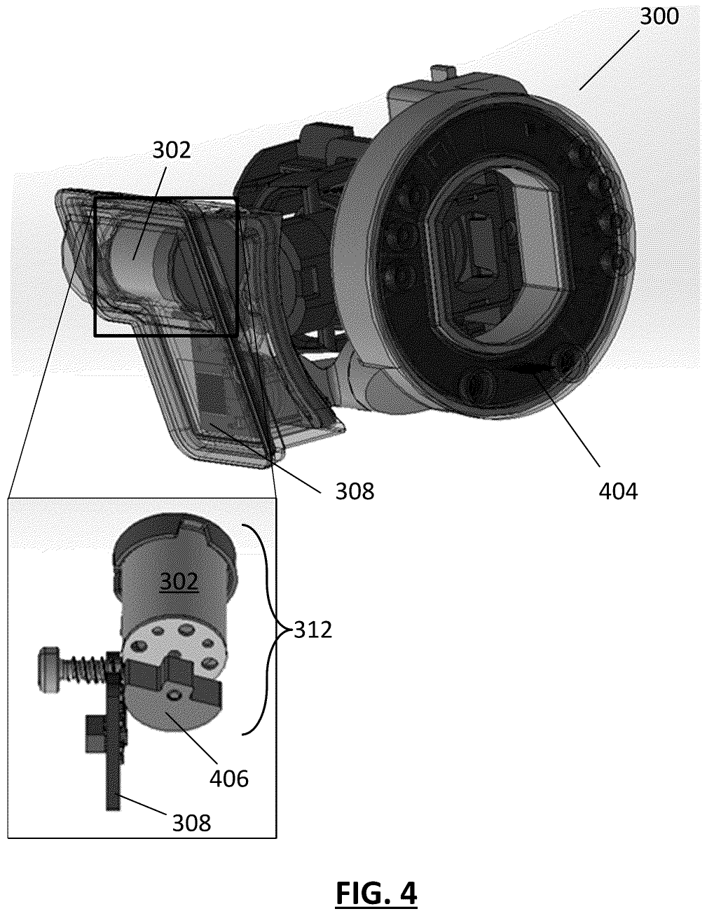

FIG. 4 provides a view of the regulator 300 where the outer housing of the regulator 300 is removed, exposing a regulator control board 404 and actuator 312. The regulator control board 404 houses the processor and memory storage for receiving and processing data received from sensor signals and transmitting alert signals to the actuator control board 308. In FIG. 4, the actuator 312 comprises a motor 302 having an eccentric mass 406 that spins on an axis to create impulses, such as part of a vibration pattern. The actuator control board 308 connected to the actuator 312 receives and transmits data, e.g., alert signals, between the regulator control board 404 and the actuator control board 308.

Although FIG. 4 depicts regulator control board 404 and actuator control board 308 as separate circuit boards in operative connection with one another, in any embodiment, these may be implemented in a single circuit board. Further, and although not depicted in FIG. 4, the respiratory protection system may comprise, as part of its overall electronic control system, one or more additional system control boards, such as a central system control board in the backplate that regulates other aspects of the respiratory protecting system. One or both of the regulator control board 404 and actuator control board 308 may be implemented in a central system control board, which may be located anywhere on the respiratory protection system, including the backplate, regulator, or any other suitable location.

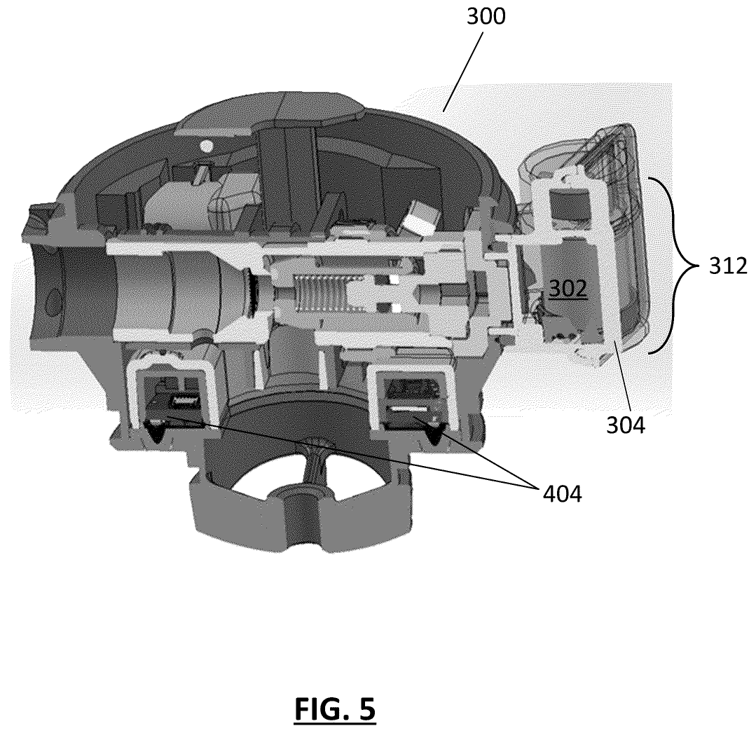

FIG. 5 is a cross-sectional view of a partial regulator assembly depicting the actuator 312 residing within actuator housing 304 that creates a seal from the rest of the regulator. FIG. 5 also depicts the regulator control board 404. Also depicted are a partial assembly of components of a demand valve, which functions to provide air flow to maintain positive pressure within the respiratory protection system. In some embodiments, actuator 312 may serve to reduce the effects of static friction between parts where relative motion is required for valve activation and operation. In other embodiments, actuator 312 may serve to help more fully settle and seal sealing interfaces within the demand valve.

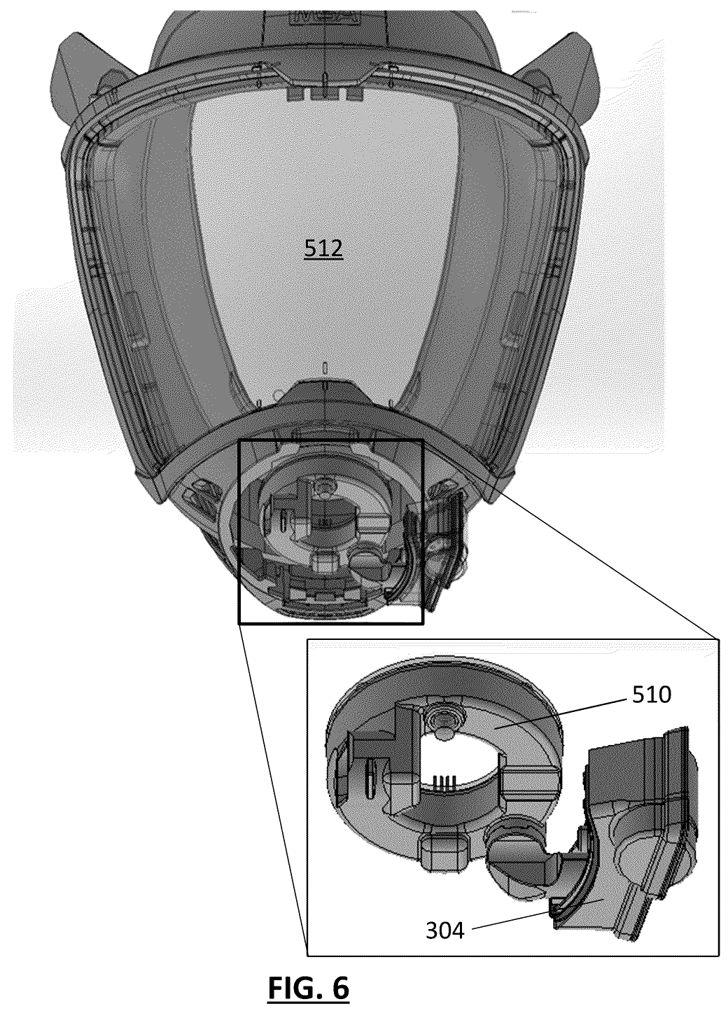

FIG. 6 depicts the implementation of an SCBA regulator comprising one embodiment of a tactile alert system as disclosed herein on the facepiece 512 of a full-face respirator. The regulator control board (not visible) resides within regulator control board housing 510 and is electronically connected to, e.g., a control board of the actuator (not visible), which is encased within actuator housing 304.

In certain embodiments, the tactile alerting system is configured to accommodate other breathing apparatus functions and peripheral device functions. For example, a regulator of a respirator may comprise a demand valve that opens and closes as a user of the respiratory protection system inhales and exhales and a sensing/switching means to detect valve opening and closing, and a corresponding signal suspending means to suspend tactile alerts when a user exhales or speaks. In certain embodiments, the sensing/switching means comprises a magnet and Hall-effect sensor that transmits a signal to the processor indicating valve status. Such a sensor may also be used in combination with audio processing techniques to detect user speech and a tactile alert system may be configured to suspend tactile alert signals when a user speaks.

With reference back to FIG. 1, a sensor 104, 114 may be a breathing sensor, such as described in U.S. Patent Application Publication No. 2017/0296094 A1, the disclosure of which is incorporated herein by reference in its entirety. For example, a breathing sensor may detect motion of a component of the regulator which moves in response to respiration of the user, for example, using a Hall-effect sensor. A magnet may be attached to a portion of the regulator that moves during respiration, for example, with the opening and closing of a demand valve. Movement of the magnet is detected by a Hall-effect sensor to determine when the user is inhaling or exhaling. In certain embodiments, the processor 106 is configured to suspend tactile alerts when the user is exhaling, such as when talking, so that any noise generated by the actuator 112 is not transmitted during speaking. In another example, the processor 106 may also be configured to suspend tactile alerts when the user is transmitting voice communications, such as when the microphone is activated, e.g., to enhance the clarity of outgoing communications. In another example, the processor 106 may also be configured to suspend tactile alerts when the user is receiving voice communications, such as when a radio broadcasts a message, e.g., to enhance the clarity of incoming communications. In yet another example, the processor 106 may also be configured to suspend tactile alerts when the user is not using the breathing apparatus, e.g., to conserve power or air.

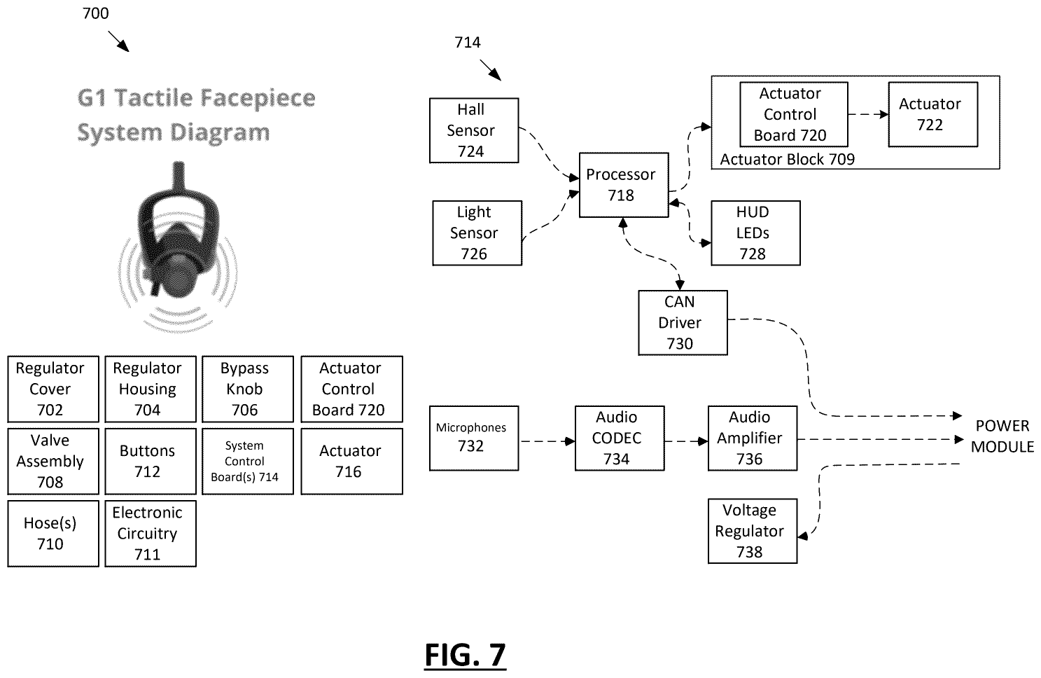

FIG. 7 is a block diagram depicting a system diagram for an exemplary tactile facepiece. The system 700 includes certain physical structures for providing the regulation of air to the user. Those physical structures include a regulator cover 702 and housing 704. Within the cover and housing are a bypass knob 706, a valve assembly 708, and a hose 710 for controlling the flow of air to the user. Certain components that are associated with a tactile alert system, in full or in part, may also be included. Those components include one or more buttons 712 for user control of the system (e.g., turning the system on, acknowledging alerts), one or more system control boards 714 for controlling the tactile alert system, an actuator 716 and actuator control board 720 for providing the tactile signal to the user, and electronic circuitry 711 for transmitting and receiving signals between system elements.

The one or more system control boards 714 may include a processor 718, as described herein, for receiving sensor signals or information from a remote location, identifying alert conditions based on the sensor signal(s) and/or information, and transmitting alert signals, such as to an actuator block 709 comprising actuator control board 720 and actuator 722. The one or more central control boards 714 is responsive to certain sensors that, in FIG. 7, include a Hall-effect sensor 724 for measuring respiration and a light sensor 726 (e.g., a photodiode) for measuring a light level. The processor 718 communicates with one or more output devices for provide output to the user. For example, the processor 718 may transmit control signals to a HUD at 728 that provide status information to the user (e.g., via LED lights provided at the periphery of the user's field of view in the regulator mask via light pipes). The processor 718 may further communicate with the actuator control board 720 to provide tactile feedback to the user by providing a signal to an actuator control board 720 that drives an actuator 722 to create mechanical impulse(s) (e.g., an eccentrically balanced brushless motor). The processor 718 may further regulate communications from the user to the exterior, such as via a microphone 732 that interacts with an audio CODEC 734 and audio amplifier 736 to provide audio signals to the exterior of the tactile facepiece. Power and communication signals may be regulated by certain hardware such as controller area network (CAN) bus 730 and a voltage regulator 738 that are communication with a power module (e.g., a battery).

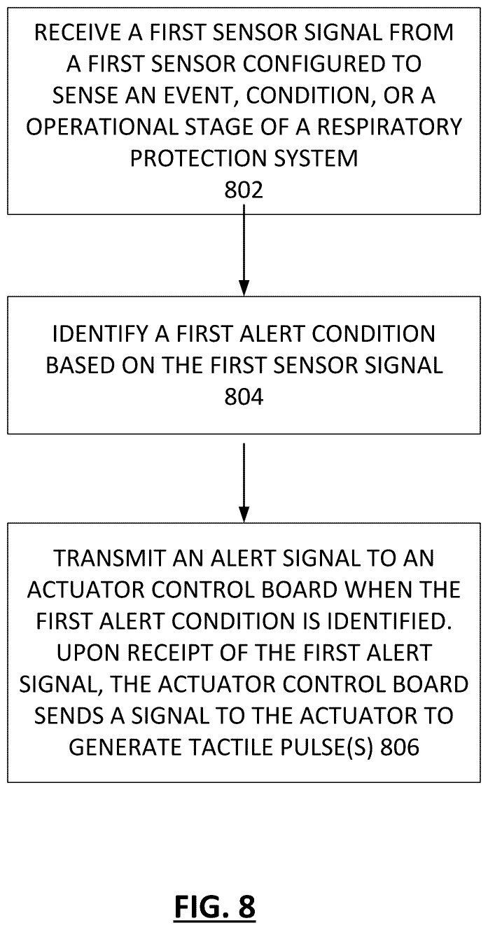

FIG. 8 is a flow diagram depicting a method for operating a tactile alerting system for monitoring conditions, events, or operational states of equipment, such as of a respiratory protection system. At 802, a sensor signal is received from a first sensor configured to sense a condition, event, or an operational state of the equipment. At 804, the tactile alert system is configured to identify an alert condition based on the first sensor signal. At 806, an alert signal is transmitted to an actuator control board and actuator when the first alert condition is identified. Upon receipt of the first alert signal, the actuator control board initiates the actuator to generate tactile impulse(s) in the PPE.

One concern in using electronically controlled elements in PPE is the aspect of intrinsic safety. The electronically tactile system as disclosed herein, is designed to prevent ignition of explosive atmospheres by limiting electrical and thermal energy to safe levels. In general, the actuator will pulse in a pattern dictated by the processor. For example, in certain embodiments, the tactile alert system may comprise a feedback loop for monitoring the performance of the actuator or the operational state of another element of the respiratory protection system. In such embodiments, actuator control board 108 and actuator 112 may be used to generate impulses, which are also detectable as acoustic signals.

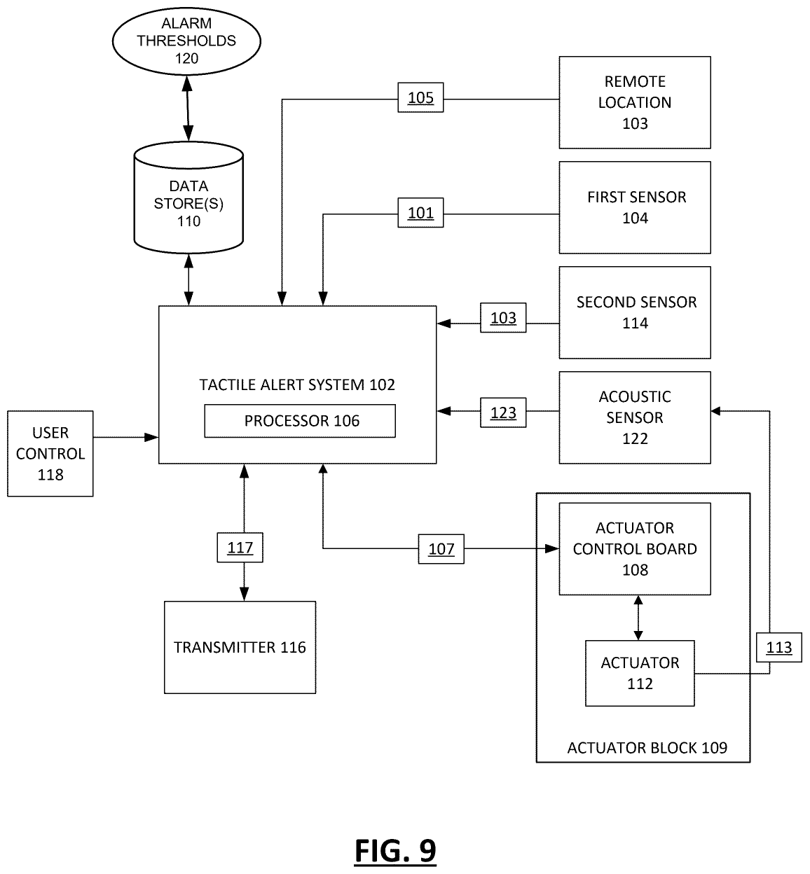

For example, as shown in FIG. 9 which comprises tactile alert system elements depicted in FIG. 1, but also includes an acoustic sensor 122. When activated, the actuator 112 emits an acoustic signal 113, which is sensed by an acoustic sensor 122, which then transmits an acoustic sensor signal 123 to the processor 106. The processor may then interpret the acoustic sensor signal 123 to determine the operational state of the actuator 112 or other element of the respiratory protection system. Operational state information can then be transmitted to a device readable by the user or to generate another tactile alert, which would also be understood by the user. In certain embodiments, the acoustic sensor 122 is a microphone. Processor 106 may also transmit operational state information via transmitter 116, and indicate operational state to user via HUD 206, or provide other indication via electronic control system 202 outputs to buddy lights, electronic audible alarm systems, or the like. Use and configuration of demand valves are well-known in the art. For example, the demand valve may be as described in U.S. Pat. No. 9,108,073 B2, the disclosure of which is incorporated herein by reference in its entirety. Use of a Hall-effect sensor is described in U.S. Patent Application Publication No. 2017/0296094 A1, the disclosure of which is incorporated herein by reference in its entirety.

In the case of an actuator 112 using a rotating mass, an acoustic signal may change as a function of the rotational speed of the actuator at a given duty cycle setting changes in response to the mass of the system to which the actuator 112 is coupled, or the degree to which it is coupled to the system mass. As such, generated acoustic signal may be modified by certain operational conditions, including whether the demand valve is activated, whether the regulator is coupled to a facepiece, whether the facepiece is donned to a user, and whether the facepiece is adequately sealed and secured to a user's face, if an air path is fully or partly obstructed, if debris or liquid is present within the regulator, or occurrence of any improperly secured or missing components.

Operational state of an element of the respiratory protection system may be determined by comparing response or output of actuator 112 (e.g., vibration frequency or intensity) may, for example, be compared to a stored predetermined response, and one or more thresholds may be predetermined to predict or determine operational state. The breathing apparatus may activate visual and/or audible indicators to indicate an operational state, which may be intended for the user and/or for nearby team members. The breathing apparatus may also record a data log event to note regulator state and/or may transmit regulator state data to a remote monitor (e.g., via telemetry). Breathing apparatus performance alerts may be activated if performance concerns are identified. Breathing apparatus performance alerts may be transmitted to a remote monitoring device (via, for example, telemetry) and can be recorded in a data log for analysis after use. In certain embodiments, the tactile alert system is configured to transmit a signal to the processor to suspend tactile alerts when the performance of the actuator meets or does not meet certain performance criteria. In certain embodiments, the actuator, including its performance, can be monitored remotely. In certain embodiments, the actuator can be controlled remotely.

The field in which the equipment implementing the tactile alerting system as disclosed herein is not particularly limited, and may be, for example, law enforcement, firefighting, oil/gas manufacturing, chemical manufacturing, and the like. In certain embodiments, the equipment is firefighting PPE. The article on which the tactile alerting system is installed is also not particularly limited provided it is in operative connection with other devices and systems that are worn on, or are in proximity of, the wearer.

Redundant alert systems in PPE are often required by law. Accordingly, in addition to the tactile alerting system as disclosed herein, which electronically controlled at least in part, a breathing apparatus, such as a SCBA, may further comprise a pneumatically controlled audible alerting system, a pneumatically controlled tactile alerting system, and/or an electronically controlled visual alerting system.

For example, pneumatically controlled audible alarms or tactile alarms may be used to alert a user when cylinder pressure reaches a predetermined value, e.g., 25-35% of the rated service pressure. Pneumatically controlled audible alerting systems may include one or more pneumatic valves in fluid connection with the cylinder. Upon reaching a predetermined pressure value, the pneumatic valve changes state to actuate either an audible alarm mechanism, such as a whistle or bell, or a tactile alarm mechanism, such as an oscillating striker or oscillating mass, in fluid connection with the pneumatic valve(s). In one embodiment, the pneumatic valve may open an air passage to permit the flow of air to an audible alarm mechanism. In another embodiment, the pneumatic valve may open an air passage to increase the air pressure upstream of an audible alarm mechanism.

In one embodiment, a breathing apparatus may comprise a HUD as an indicator of, e.g., remaining cylinder pressure, system battery status, or other vital alerts. In addition to a HUD, a breathing apparatus may also comprise other visual alerts, such as buddy lights. The processor may be configured to manage and transmit signals based on data, such as air pressure sensor data, battery state of charge data, PASS status, remaining cylinder pressure, and subsystem state data, to actuate visible alerts. One example of a HUD that may be incorporated into the breathing apparatus, such as a SCBA, together with an electronically controlled tactile alerting system is described in U.S. Pat. No. 9,108,073 B2, the disclosure of which is incorporated herein by reference in its entirety.

A SCBA, in certain embodiments, may comprise a backplate that positions and secures various components of the breathing apparatus, such as one or more cylinders, pneumatic assemblies, and electronic assemblies. The backplate system may comprises one or more harnesses, e.g., to position and secure the breathing apparatus to the wearer.

Actions by the processor herein may be implemented using any suitable processing system with any suitable combination of hardware, software, and/or firmware, provided it functions in the manner disclosed herein. One example of a processor is disclosed in U.S. Patent Application Publication No. 2017/0296094 A1, the disclosure of which is incorporated herein by reference in its entirety.

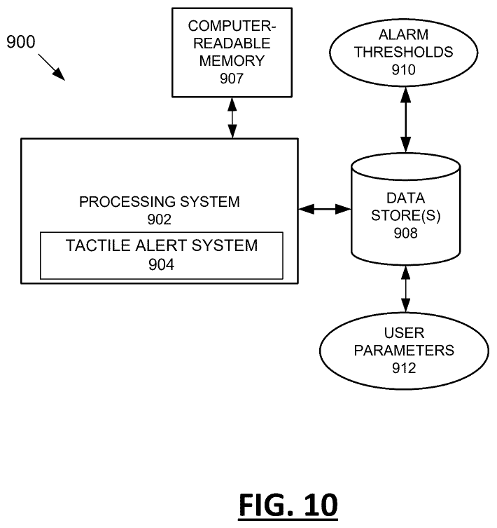

FIG. 10 depicts an exemplary system 900 that includes a standalone computer architecture where a processing system 902 (e.g., one or more computer processors located in a given computer or in multiple computers that may be separate and distinct from one another) includes a computer-implemented tactile alert system 904 being executed on the processing system 902. The processing system 902 has access to a computer-readable memory 907 in addition to one or more data stores 908. The one or more data stores 908 may include alarm thresholds 910 as well as user parameters 912. The processing system 902 may be a distributed parallel computing environment, which may be used to manage very large-scale data sets.

The term “electronically controlled” refers to use of electronic circuitry to receive, process, and convey information. “Circuitry” as used herein includes, but is not limited to, hardware, firmware, software, or combinations of each to perform a function(s) or an action(s). For example, based on a desired feature or need, a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random-access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

The processor may be configured to identify alert conditions based on those sensor signals using at least one algorithm stored in a memory system in operative connection with the processor, which executes the at least one algorithm. The memory system may store a plurality of algorithms, each configured to process data received from each of the sensors incorporated into the breathing apparatus. For example, there may be a separate algorithm stored to process pressure data, respiration data, temperature data, motion data, receipt of remote signals, and the like. For example, an algorithm for use in a breathing sensor may be configured to determine at least one of a rate of respiration and a respiration volume from data from the breathing sensor. In another example, an algorithm for use in a pressure sensor may be configured to determine the amount of air remaining in a SCBA cylinder from data from the pressure sensor.

In certain embodiments, an algorithm may be stored to receive and process data from multiple sensors. For example, data received from a breathing sensor and a motion sensor may be processed to determine the physiological state of a user and determine if the user is in distress.

In certain embodiments, the algorithm may comprise stored ranges associated with stable or normal condition and stored ranges associated with unstable or abnormal condition. For example, an algorithm for use in a breathing sensor may comprise stored ranges of respiration rate associated with predetermined physiological states of the user. In another example, an algorithm for use in a pressure sensor may comprise stored ranges of associated with different volumes of air left, e.g, 75%, 50%, 35%, 10%, and less than 5%.

The algorithm is programmed to transit a signal to the tactile actuator upon determination of an unstable or abnormal operation, such as low cylinder volume, to activate the tactile alarm and bring the user's attention to the unstable condition.

In addition to the electronic control system, the breathing apparatus also includes at least one power module in communicative connection with the control system to provide power thereto.

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an,” and “the” include plural references unless the context clearly dictates otherwise. Thus, for example, reference to “a light source” includes a plurality of such light sources and equivalents thereof known to those skilled in the art, and so forth, and reference to “the light source” is a reference to one or more such light sources and equivalents thereof known to those skilled in the art, and so forth.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A tactile alerting system for indicating information to a user of a respiratory protection system, comprising:
a. a first sensor configured to sense a condition, event, or operational state of the respiratory protection system and to generate a first sensor signal based on the condition, event, or operational state;
b. a processor configured to
i. receive the first sensor signal;
ii. identify a first alert condition based on the first sensor signal; and
iii. transmit a first alert signal when the first alert condition is identified; and
c. an actuator configured to receive a command based on the first alert signal and generate one or more tactile impulses in one or more components of the respiratory protection system based on the command.

2. The tactile alerting system of claim 1, wherein the processor is further configured to:
i. receive a second signal from the first sensor,
ii. identify a subsequent alert condition based on the second signal from the first sensor, and
iii. transmit a subsequent alert signal.

3. The tactile alerting system of claim 1, further comprising a second sensor configured to generate a second sensor signal,
wherein the processor is configured to identify a second alert condition based on the second sensor signal and transmit a second alert signal when the alert signal is identified, and
wherein the tactile alerting system is configured to command the actuator to generate tactile impulses based on the second alert signal.

4. The tactile alerting system of claim 3, wherein the tactile alerting system is configured to command the actuator to generate tactile impulses according to a first pattern based on the first alert signal and tactile impulses according to a second pattern based on the second alert signal.

5. The tactile alerting system of claim 3, wherein the processor is configured to identify a second alert condition based on both the first sensor signal and the second sensor signal.

6. The tactile alerting system of claim 3, wherein the processor is configured to command the actuator to alternate tactile impulses according to the first pattern and tactile impulses according to the second pattern when the processor identifies both the first alert condition and the second alert condition at the same time.

7. The tactile alerting system of claim 1, wherein the actuator is directly or indirectly coupled to a respiratory mask.

8. The tactile alerting system of claim 3, wherein one of the first and second sensors is a pressure sensor configured to monitor an air supply associated with a breathing apparatus.

9. The tactile alerting system of claim 3, wherein one of the first or second sensors is a motion sensor.

10. The tactile alerting tactile alerting system of claim 9, wherein the first and second patterns are different.

11. The tactile alerting system of claim 1, wherein the processor is further configured to:
i. receive information from a remote location, which is interpreted by the processor to identify a second alert condition; and
ii. transmit a second alert signal when the second alert condition is identified,
wherein tactile alert system is configured to generate tactile impulses by the actuator upon receipt of the second alert signal from the processor, and
wherein tactile impulses based on the second alert signal are according to a second pattern.

12. The tactile alerting system of claim 11, wherein the remote alert signal is a signal from a tactile alert system of another user.

13. The tactile alerting system of claim 12, wherein the remote alert signal from the tactile alerting system of another user is a signal from a motion sensor.

14. The tactile alerting system of claim 11, wherein the remote alert signal comprises information from a remote monitoring location.

15. The tactile alerting system of claim 14, wherein the information from the remote monitoring location is an evacuation order.

16. The tactile alerting system of claim 1, wherein tactile impulses change in one or more of amplitude, frequency, or timing based on an amount of time in which the tactile alert system is in alert condition.

17. The tactile alerting system of claim 1, wherein tactile impulses change in one or more of amplitude, frequency, or timing based on sensor signal levels.

18. The tactile alerting system of claim 1, wherein the tactile alert comprises a pattern of impulses varying in one or more of duration, intensity, amplitude, and frequency.

19. The tactile alerting system of claim 1, wherein a plurality of distinct tactile impulse patterns is used to indicate distinct information to a user.

20. The tactile alerting system of claim 1, wherein the actuator is electronically activated and/or deactivated.

21. The tactile alerting system of claim 1, wherein the actuator uses electricity as an energy source to generate mechanical impulse(s).

22. The tactile alerting system of claim 1, wherein the actuator uses air flow and/or pressure as an energy source to generate mechanical impulse(s).

23. The tactile alerting system of claim 1, wherein the actuator creates mechanical impulse(s) by rotating an eccentric mass.

24. The tactile alerting system of claim 1, wherein the mechanical impulse(s) of the actuator is generated by rotating a rotationally imbalanced mass.

25. The tactile alerting system of claim 1, wherein the actuator comprises a rotating motor with a speed range of 1 rpm to 20,000 rpm, an eccentric mass of 1 g to 5 g, and an eccentricity of the mass center of gravity from the axis of rotation of 1 mm to 5 mm.

26. The tactile alerting system of claim 1, wherein the respiratory protection system is firefighter personal protective equipment.

27. The tactile alerting system of claim 1, wherein the respiratory protection system is a respirator.

28. The tactile alerting system of claim 27, wherein the respirator is a full-face respirator of a self-contained breathing apparatus (SCBA).

29. The tactile alerting system of claim 27, wherein the respirator is an air-purifying respirator.

30. The tactile alerting system of claim 1, wherein the actuator is coupled to an SCBA regulator.

31. The tactile alerting system of claim 1, wherein the processor is on a SCBA regulator.

32. The tactile alerting system of claim 1, wherein the actuator is implemented on a regulator of combined respirator unit.

33. The tactile alerting system of claim 32, wherein the regulator comprises a demand valve that opens and closes as a user of the respiratory protection system inhales and exhales and a sensing/switching means to detect valve opening and closing, and a corresponding signal suspending means to suspend tactile alerts when a user exhales or speaks.

34. The tactile alerting system of claim 33, wherein the sensing/switching means comprises a magnet and Hall-effect sensor that transmits a signal to the processor indicating valve status.

35. The tactile alerting system of claim 1, wherein audio processing techniques are implemented to detect user speech, and a corresponding tactile signal suspending means is provided to suspend tactile alerts when a user speaks.

36. The tactile alerting system of claim 1, wherein the performance of the actuator can be monitored remotely.

37. The tactile alerting system of claim 36, wherein the actuator can be controlled remotely.

38. The tactile alerting system of claim 1, further comprising an interface by which a user of the respiratory protection system can acknowledge the tactile alert.

39. The tactile alerting system of claim 38, wherein the processor is configured to transmit a tuning signal to the actuator upon receiving an acknowledgment signal initiated by the user.

40. The tactile alerting system of claim 1, further comprising an interface by which a user of the respiratory protection system can control the intensity of the tactile alert.

41. The tactile alerting system of claim 1, wherein the actuator can be manually activated and deactivated.

42. A SCBA respirator comprising the tactile alerting system of claim 1.
